(19) United States
(12) Patent Application Publication
(10) Pub. No.: US 2009/0323481 A1
(43) Pub. Date: Dec. 31, 2009

(54) DRIVE APPARATUS AND TRACK JUMP METHOD

(75) Inventors: Masaaki HARA, Tokyo (JP); Satoru SEKO, Kanagawa (JP); Hitoshi Okada, Chiba (JP); Tomiji TANAKA, Saitama (JP); Yoshiki OKAMOTO, Kangawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/476,397

(22) Filed: Jun. 2, 2009

(30) Foreign Application Priority Data
Jun. 25, 2008 (JP) 2008-166244

(51) Int. Cl. G11B 7/00

(52) U.S. Cl. 369/44.23; 369/103; G9B/7

(57) ABSTRACT

A drive apparatus includes a light irradiation section for applying light from a light source via an object lens on a hologram recording medium having a recording layer on which a hologram is formed and a track formation layer on which an address recording track composed of a pit string recording address information representing the hologram recording position on the recording layer and an auxiliary track composed of a continuous groove formed side by side with the address recording track are formed, a light spot displacement section for displacing a light spot formed by the light irradiation section in a radius direction of the hologram recording medium, and a control section for controlling the light spot displacement section following a light information signal upon the auxiliary track traverse of the light spot obtained in accordance with the light spot displacement to execute a jump operation between the address recording tracks.

### BACKGROUND OF THE INVENTION

1. Field of the Invention

The present invention relates to a drive apparatus configured to perform recording and reproduction with respect to a hologram recording medium which is provided with a recording layer on which a hologram is recorded and a track formation layer on which a track is formed for representing a recording position of the hologram on the recording layer and also relates to a track jump method.

2. Description of the Related Art

As described, for example, in Japanese Unexamined Patent Application Publication No. 2005-250038 and Japanese Unexamined Patent Application Publication No. 2007-79438, a hologram recording and reproduction system is proposed which is configured to form a hologram by way of an interference pattern of a signal light and a reference light to perform data recording. In this hologram recording and reproduction system, at the time of the recording, a hologram recording medium is irradiated with a signal light to which a spatial light modulation in accordance with recording data (for example, light intensity modulation) is effected and also irradiated with a reference light which is different from this signal light, and a hologram (diffraction grating) by way of an interference pattern of those lights is formed on the medium to perform the data recording.

Also, at the time of the reproduction, the hologram recording medium is irradiated with a reference light. With this irradiation with the reference light, it is possible to obtain a diffraction light in accordance with obtainment of the hologram formed on the hologram recording medium in the above-mentioned manner. That is, with this procedure, a reproduction light in accordance with the recording data can be obtained. By detecting the thus obtained reproduction light by an image sensor such as for example a CCD (Charge Coupled Device) sensor or a CMOS (Complementary Oxide Semiconductor) sensor, the recording data is reproduced.

Herein, for the hologram recording and reproduction system, for example, similarly as in an optical disc recording and reproduction system in a related art such as a CD (Compact Disc) or a DVD (Digital Versatile Disc), it is also conceived that data is recorded along a track formed on a medium. That is, similarly as in the related art optical disc, by performing a recording/reproduction positional control such as tracking servo, the data recording is carried out along the track.

At this time, as a specific structure of the recording medium, two layers are provided including a recording layer for recording a hologram and a track formation layer on which a pit string which records, on a lower layer thereof, address information and the like is formed, for example, in a spiral manner or a concentric manner. That is, according to the above-mentioned structure of the hologram recording medium, by controlling an irradiation position of the light for the hologram recording/reproduction while following the track composed of the pit string on the track formation layer, the recording/reproduction position of the hologram on the recording layer can be set at a position along the track.

### SUMMARY OF THE INVENTION

Herein, in the hologram recording and reproduction system for performing the above-mentioned recording and reproduction on the hologram recording medium, an examination is given on a track jump operation to a target track.

In the hologram recording medium, the track composed of the pit string is formed on the track formation layer in a spiral manner or a concentric manner as described above. From this viewpoint, similarly as in a case of the optical disc recording and reproduction system in the related art, it is conceivable that the track jump operation is carried out by utilizing a reflection light signal when a light spot is moved in a radius direction (so called traverse signal).

However, in the hologram recording and reproduction system, a rotation speed of the recording medium is set considerably slower than the optical disc recording and reproduction system in the related art. This is because light irradiation is used for a relatively long period of time for recording (forming) the hologram.

From this viewpoint, in the case of the hologram recording and reproduction system, when the light spot traverses the track composed of the pit string, in some cases, the light spot traverses a space part (land part) between pits, and the track traverse may not be appropriately detected.

That is, regarding this point, in the hologram recording and reproduction system, if a track jump operation similar to the case of the optical disc in a related art is performed as it is, the jump operation to the target track may not be appropriately carried out.

In order to solve the above-mentioned problem, according to an embodiment of the present invention, it is desirable to configure a drive apparatus as follows.

That is, there is provided a drive apparatus including: light irradiation means configured to apply light from a light source via an object lens on a hologram recording medium provided with a recording layer on which a hologram is formed and a track formation layer on which an address recording track composed of a pit string which records address information representing a recording position of the hologram on the recording layer and an auxiliary track composed of a continuous groove formed so as to run side by side with the address recording track are formed; light spot displacement means configured to displace a light spot formed by the light irradiation means in a radius direction of the hologram recording medium; and control means configured to control the light spot displacement means on the basis of a light information signal at the time of the auxiliary track traverse of the light spot obtained in accordance with displacement of the light spot in the radius direction to execute a jump operation between the address recording tracks.

As described above, on the hologram recording medium according to the embodiment of the present invention, the auxiliary track composed of the continuous groove is formed so as to run side by side with the address recording track composed of the pit string on which the address information is recorded.

Then, according to the embodiment of the present invention, by controlling the radius direction position of the light spot on the basis of the light information signal at the time of the traverse across the auxiliary track composed of the continuous groove which is formed on the hologram recording medium in the above-mentioned manner, the jump operation between the address recording tracks is carried out.

As the auxiliary track is composed of the continuous groove, even in a case where the rotation speed is slow, the traverse can be detected with certainty. Then, this auxiliary track is formed so as to run side by side with the address recording track. Therefore, according to the embodiment of the present invention, the jump operation between the address recording tracks is performed on the basis of the light information signal at the time of the traverse across the auxiliary track as in the above-mentioned manner, the jump operation between the address recording tracks can be appropriately carried out.

As described above, according to the embodiment of the present invention, the track jump operation between the address recording tracks on which the address information is recorded can be appropriately carried out. That is, with this configuration, it is possible to provide the system in which the access operation to the target address can be appropriately performed as the hologram recording and reproduction system for performing the recording/reproduction of the hologram at the position along the track.

### BRIEF DESCRIPTION OF THE DRAWINGS

FIG. 1 is a block diagram of an internal configuration of a drive apparatus according to an embodiment of the present invention;

FIG. 2 shows a cross sectional structure of a hologram recording medium according to the embodiment of the present invention;

FIG. 3 schematically shows a track formed on a track formation layer of the hologram recording medium according to the embodiment of the present invention;

FIGS. 4A and 4B are explanatory diagrams for describing a one track jump operation according to the embodiment of the present invention;

FIG. 5 is a flow chart of a procedure for a processing that should be executed for realizing the one track jump operation according to the embodiment of the present invention;

FIG. 6 is a flow chart of a procedure for a processing that should be executed for realizing a track jump operation (general track jump operation) according to the embodiment of the present invention;

FIG. 7 is an explanatory diagram for describing a first example of a second embodiment of the present invention;

FIG. 8 is an explanatory diagram for describing a second example of a second embodiment of the present invention; and

FIG. 9 shows a cross sectional structure of a hologram recording medium according a modification example of the present invention.

### DESCRIPTION OF THE PREFERRED EMBODIMENTS

Hereinafter, a description will be provided of preferred modes for carrying out the present invention (which are hereinafter referred to as embodiments).

### First Embodiment

### Configuration of Recording Apparatus and Structure of Hologram Recording Medium

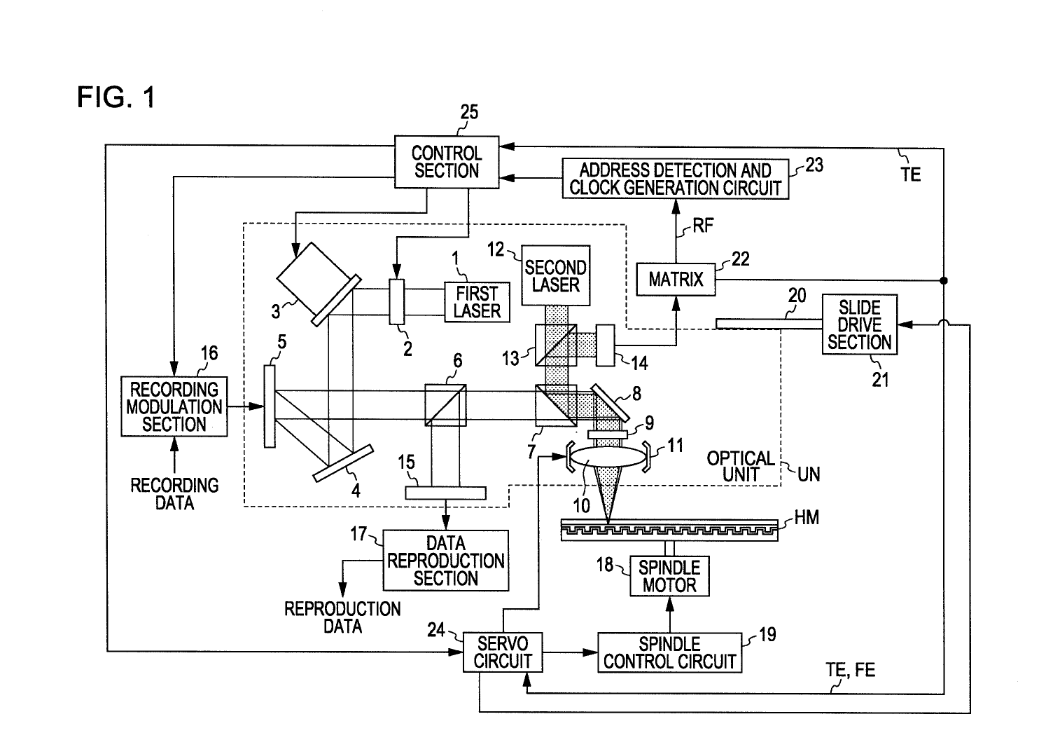

FIG. 1 is a block diagram of an internal configuration of a drive apparatus according to an embodiment of the present invention. The drive apparatus according to the embodiment is configured as a recording and reproduction apparatus having a function of recording data on a hologram recording medium HM and also a reproduction function. From this viewpoint, the drive apparatus according to the embodiment shown in FIG. 1 will be hereinafter referred to as recording and reproduction apparatus.

First, according to the present embodiment, as a hologram recording and reproduction system, a so-called coaxial system is adopted. That is, a signal light and a reference light are arranged on the same axis, and the hologram recording medium HM set at a predetermined position is irradiated with those lights to form a hologram based on an interference pattern to perform data recording. Also, at the time of reproduction, the hologram recording medium HM is irradiated with a reference light to obtain a reproduction light of the hologram to thereby perform the reproduction of the recording data.

In this case, the hologram recording medium HM in the drawing has a disc shape (disc-like shape), and the recording and reproduction apparatus shown in FIG. 1 performs recording and reproduction of data by rotating and driving the hologram recording medium HM.

As will be described below in detail, a track composed of a pit string is formed in a spiral manner or a concentric manner on the hologram recording medium HM of this case, and the recording and reproduction apparatus according to the first embodiment is operated so as to perform the recording/reproduction of the data on the track formed in the above-mentioned manner.

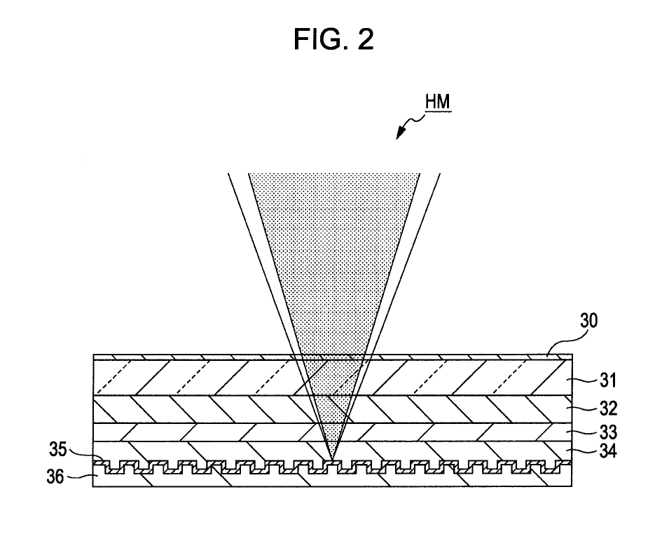

Herein, the structure of the hologram recording medium HM used in the present embodiment will be described with reference to FIG. 2.

FIG. 2 shoes a cross sectional structural diagram of the hologram recording medium HM.

First, on the premise, the recording and reproduction apparatus of this case separately applies a laser light for recording the hologram based on the interference pattern and a laser light for controlling recording/reproduction positions for performing the recording/reproduction of the hologram along the track (tracking servo or the like).

As will be also described, to be specific, for example, a first laser 1 for outputting a violet-blue laser light having a wavelength of about 405 nm is used as a laser light source for the recording/reproduction of the hologram. Also, for example, a second laser 12 for outputting a red laser light having a wavelength of about 650 nm is used as a laser light source for the above-mentioned positional control.

In accordance with this, as shown in FIG. 2, a recording layer 32 where the recording/reproduction of the hologram is performed and a positional control information recording layer on which address information for the positional control based on a concave and convex cross sectional structure of a substrate 36 (a reflection film 35) shown in the drawing and the like are recorded are separately formed in the hologram recording medium HM used in the present embodiment.

The cross sectional structure of the hologram recording medium HM will be specifically examined.

As shown in FIG. 2, on the hologram recording medium HM, from an upper layer in order, an anti reflection film 30, a cover layer 31, the recording layer 32, a reflection film 33, an intermediate layer 34, the reflection film 35, and the substrate 36 are formed.

The anti reflection film 30 is formed by applying AR (Anti Reflection) coating and has a function of preventing unwanted light reflection. In addition, the cover layer 31 is composed of, for example, a plastic substrate, a glass plate, or the like and is provided for protecting the recording layer 32.

As a material of the recording layer 32, for example, photo polymer is selected. As described above, by using the first laser 1 shown in FIG. 1 as the light source, the recording/reproduction of the hologram based on the violet-blue laser light is performed.

Also, the reflection film 33 is provided so as to return to the recording and reproduction apparatus side as the reflection light and the reproduction light in accordance with the hologram recorded on the recording layer 32 when the reference light based on the violet-blue laser light is applied at the time of the reproduction.

The substrate 36 and the reflection film 35 are provided for a recording/reproduction positional control.

On the substrate 36, a track for guiding the recording/reproduction position of the hologram in the recording layer 32 is formed in a spiral manner or a concentric manner. In the hologram recording medium HM according to the present embodiment, as this track, a track (address recording track) based on a pit string where at least address information is recorded is formed.

It should be noted that a detail of the track formed on the hologram recording medium HM according to the present embodiment will be described.

On a surface (front surface) on which the above-mentioned track is formed on the substrate 36, the reflection film 35 is formed, for example, through spattering, vapor deposition, or the like. The intermediate layer 34 formed between the reflection film 35 and the reflection film 33 described above is made, for example, of an adhesive material such as resin.

Herein, as is understood from the above-mentioned explanation, in order to appropriately perform the positional control by way of the red laser light using the second laser 12 as the light source, the red laser light should reach the reflection film 35 to which the concave and convex cross sectional shape for the positional control is provided. That is, from this viewpoint, the red laser light should transmit through the reflection film 33 which is formed on an upper later than the reflection film 35.

On the other hand, as the reflection film 33, the violet-blue laser light should be reflected so that the reproduction light in accordance with the hologram recorded on the recording layer 32 is returned as the reflection light to the recording and reproduction apparatus side.

From this viewpoint, the reflection film 33 formed between the recording layer 32 and the reflection film 35 on which the positional control information is recorded is configured to have a wavelength selectivity of reflecting the violet-blue laser light (for example, having a wavelength of about 405 nm) for the recording/reproduction of the hologram and of transmitting the red laser light for the positional control (for example, having a wavelength of about 650 nm).

With the reflection film 33 having such a wavelength selectivity, at the time of the recording/reproduction, the red laser light appropriately reaches the reflection film 35, the reflection light information for the positional control is appropriately detected on the recording and reproduction apparatus side, and also the reproduction light of the hologram recorded on the recording layer 32 can be appropriately detected by the recording and reproduction apparatus.

It should be noted that as is understood from the above-mentioned explanation, the reflection film 35 is provided with the concave and convex cross section shape in accordance with the surface shape of the substrate 36 located on the lower layer thereof, and the track is formed. In this sense, the reflection film 35 is also referred to as track formation layer.

Herein, as described above, an address recording track composed of a pit string on which address information is recorded is formed the track formation layer functioning as the reflection film 35.

In the case of the present example, the “address” indicated by the address information recorded on this address recording track refers, for example, to an address units of a predetermined sector. That is, in the hologram recording medium HM of the present example, the track is divided into a plurality of sectors. Each sector stores track number information indicating a track number where the sector exists and sector number information of the sector as the address information.

As an example, in each sector, the track number information is stored, for example, at the leading position. Then, the sector number information is stored at a position following the track number information in each sector.

While referring back to FIG. 1, the internal configuration of the recording and reproduction apparatus will be described.

In FIG. 1, in the recording and reproduction apparatus, a medium holding section (not shown) configured to hold the hologram recording medium HM is provided. When the hologram recording medium HM is mounted in the recording and reproduction apparatus, the medium holding section holds the hologram recording medium HM so as to be rotated and driven by a spindle motor 18. In the recording and reproduction apparatus, the hologram recording medium HM to be rotated and driven is irradiated with the laser light using the first laser 1 as the light source to perform recording/reproduction of a hologram page.

The first laser 1 is composed, for example, of a laser diode provided with an external resonator, and as described above, the wavelength of the laser light is set as about 405 nm. Hereinafter, the laser light using the first laser 1 as the light source is referred to as first laser light.

The first laser light applied from the first laser 1 enters a shutter 2. Opening and closing operations of the shutter 2 is controlled by a control section 25 which will be described below, and the incident light is interrupted/transmitted.

The first laser light via the shutter 2 is guided to a Galvano mirror 3 as shown in the drawing. The Galvano mirror 3 is provided for realizing a so-called image stabilizing function.

Herein, the recording and reproduction apparatus according to the present embodiment is configured to irradiate the hologram recording medium HM to be rotated and driven with the signal light and the reference light to perform the recording of the hologram.

At this time, in order to record the hologram as an interference pattern of the signal light and the reference light, it takes a response time of the recording material in the recording layer 32.

For this reason, in the system for performing the rotation recording with respect to the hologram recording medium HM, the irradiation position of the signal light and the reference light is paused at a certain position on the hologram recording medium HM for a certain period of time, and thus the laser beam is scanned. To be specific, by changing an emitting angle of the laser beam at a speed in synchronization with the rotation speed of the hologram recording medium HM (the rotation speed of the spindle motor 18), the irradiation spot of the signal light and the reference light remains at the certain position on the hologram recording medium HM for the certain period of time.

The Galvano mirror 3 changes the emitting angle of the reflection light of the incident light on the basis of the control of the control section 25.

The light emitted from the Galvano mirror 3 is reflected by a mirror 4 and guided to an SLM (spatial light modulator) 5.

The SLM 5 applies, for example, a spatial light intensity modulation for a spatial light modulation on the incident light. In this case, the SLM 5 is of a reflection type and, for example, a spatial light modulator such as a DMD (Digital Micromirror Device: registered trademark) or a reflective liquid crystal panel is adopted.

The SLM 5 applies the spatial light intensity modulation in units of pixel on the incident light by changing the light intensity by the respective intensity modulation elements on the basis of a drive signal supplied from a recording modulation section 16 shown in the drawing.

The recording modulation section 16 performs the drive control with respect to the SLM 5 to generate the signal light and the reference light at the time of the recording and to generate only the reference light at the time of the reproduction.

To be precise, at the time of the recording, the recording modulation section 16 generates a drive signal, for example, so that pixels in a predetermined area including a central part of the SLM 5 (signal light area) have ON/OFF patterns in accordance with the supplied recording data, pixels in a predetermined range on the outer circumference side of the signal light area (referred to as reference light are) have predetermined ON/OFF patterns, and the other pixels are all OFF, and supplies this drive signal to the SLM 5. As the spatial light intensity modulation is performed by the SLM 5 on the basis of the drive signal, the signal light and the reference light are generated.

Also, at the time of the reproduction, the recording modulation section 16 generates a drive signal so that the pixels in the reference light area have the above-mentioned predetermined ON/OFF patterns and the other pixels are all OFF to drive and control the SLM 5 to thereby generate only the reference light.

It should be noted that at the time of the recording, the recording modulation section 16 is operated to generate ON/OFF patterns in the signal light area in predetermined units of input recording data, and thus the signal lights storing the above-mentioned data in predetermined units of the recording data are sequentially generated. With this configuration, the data recording is sequentially carried out on the hologram recording medium HM in units of hologram page (units of data stored in the signal light).

The light to which the spatial light modulation is applied by the SLM 5 transmits through a polarization beam splitter 6 and then enters a dichroic mirror 7.

The dichroic mirror 7 is configured to transmit the first laser light and reflect a second laser light (a light using the second laser 12 as the light source). For this reason, the first laser light transmitting through the polarization beam splitter 6 transmits through the dichroic mirror 7 and is reflected by a mirror 8 as shown in the drawing. The hologram recording medium HM is irradiated with the first laser light via an objective lens 10 held by a biaxial mechanism 11 after travelling via a ¼ wavelength plate 9.

The biaxial mechanism 11 holds the objective lens 10 so as to be displaced in a direction to be close to or away from the hologram recording medium HM (focus direction) and a radius direction of the hologram recording medium HM (direction orthogonal to the focus direction: tracking direction). In addition, the biaxial mechanism 11 is provided with a focus coil for driving the objective lens 10 in the focus direction and a tracking coil for driving the objective lens 10 in the tracking direction.

Herein, the hologram recording medium HM is irradiated with the first laser light travelling via the SLM 5 in the above-mentioned manner via the objective lens 10. Depending of the spatial light modulation performed by the SLM 5, the signal light and the reference light based on the first laser light are generated, and therefore, at the time of the recording, the hologram recording medium HM is irradiated with the signal light and the reference light. In this way, the hologram recording medium HM is irradiated with the signal light and the reference light, and thus the diffraction grating (hologram) based on the interference pattern of these lights is formed on the recording layer 32 to perform the data recording.

Also, at the time of the reproduction, only the reference light is generated by the SLM 5, and the hologram recording medium HM is irradiated with the reference light travelling via the above-mentioned optical path. In accordance with the irradiation of the hologram recording medium HM with the reference light, the diffraction light (reproduction light) is obtained in accordance with the recorded hologram. The reproduction light obtained in this way is set to be returned to the apparatus side as the reflection light from the reflection film 33 of the hologram recording medium HM.

The reproduction light is set as the parallel light via the objective lens 10 and reflected by the mirror 8 via the ¼ wavelength plate 9. After that, The reproduction light transmits through the dichroic mirror 7 and enters the polarization beam splitter 6.

In the polarization beam splitter 6, the incident reproduction light is reflected. The reflection light from the polarization beam splitter 6 enters an image sensor 15 as shown in the drawing.

The image sensor 15 is composed, for example, of a CCD (Charge Coupled Device) sensor, a CMOS (Complementary Metal Oxide Semiconductor) sensor, or the like. The image sensor 15 receives the reproduction light guided in the above-mentioned manner from the hologram recording medium HM and converts the reproduction light into an electric signal to obtain an image signal. The thus obtained image signal reflects the “0”/“1” data pattern provided to the signal light at the time of the recording (in other words, the ON/OFF pattern of the light). That is, the image signal detected by the image sensor 15 in this way is comparable to a read signal of the data recorded on the hologram recording medium HM.

For each value of the pixel unit of the SLM 5 which is included in the image signal detected by the image sensor 15, A data reproduction section 17 performs the “0”/“1” data identification, and when occasion demands, the demodulation processing of the recorded modulation code and the like, to reproduce the recording data.

Also, in this recording and reproduction apparatus shown in FIG. 1, regarding the recording/reproduction of the hologram operation carried out by using the first laser light as described above, an optical system is provided for performing a control on the recording/reproduction position. To be specific, the optical system is composed of the second laser 12, a polarization beam splitter 13, and a photo detector 14 shown in the drawing.

The second laser 12 is configured to apply a laser light having a wavelength different from the first laser light. To be specific, the second laser 12 outputs the above-mentioned red laser light having a wavelength of about 650 nm.

It should be noted that a wavelength difference between the first laser 1 and the second laser 12 in this case is about 250 nm. With the provision of such a sufficient wavelength difference, the laser light using the second laser 12 as the light source (the second laser light) basically has almost no sensitivity with respect to the recording layer 32 of the hologram recording medium HM.

After transmitting through the polarization beam splitter 13, the second laser light emitted from the second laser 12 is reflected by the dichroic mirror 7 and guided to the mirror 8 side. The hologram recording medium HM is irradiated with the second laser light thus guided to the mirror 8 side following the path similar to the case of the above-mentioned first laser light.

It should be noted that as is understood from this viewpoint, the dichroic mirror 7 has a function of irradiating the hologram recording medium HM while the optical axis of the first laser light and the optical axis of the second laser light are matched with each other.

As described above in FIG. 2, in the hologram recording medium HM, the thus applied second laser light transmits through the reflection film 33 and is reflected by the reflection film 35 locating on the lower layer thereof. To elaborate, the reflection light reflecting the concave and convex cross section shape (pit string) on the reflection film 35 is thus obtained.

Also, the reflection light from the reflection film 35 enters the dichroic mirror 7 similarly as in the case of the above-mentioned first laser light via the objective lens 10→the ¼ wavelength plate 9→the mirror 8.

In the dichroic mirror 7, the reflection light regarding the second laser light reflected from the hologram recording medium HM is reflected, and this reflection light is guided to the polarization beam splitter 13 side. In the polarization beam splitter 13, the reflection light from the hologram recording medium HM is reflected, and this reflection light is guided to the photo detector 14 side.

The photo detector 14 is provided with a plurality of light receiving elements and configured to receive the reflection light from the thus guided hologram recording medium HM to be converted into an electric signal and to supply the electric signal to a matrix circuit 22.

The matrix circuit 22 is provided with a matrix computation and amplification circuit and the like with respect to the output signals from the plurality of light receiving elements functioning as the photo detectors 14 and configured to generate signals through a matrix computation processing.

For example, a signal comparable to the reproduction signal for the pit string formed on the hologram recording medium HM (a reproduction signal RF) and a focus error signal FE, a tracking error signal TE, and the like for the servo control are generated.

The reproduction signal RF output from the matrix circuit 22 is supplied to an address detection and clock generation circuit 23. In addition, the focus error signal FE and the tracking error signal TE are supplied to a servo circuit 24.

Also, in the case of the present example, the tracking error signal TE generated in the matrix circuit 22 is also supplied to the control section 25.

The address detection and clock generation circuit 23 detects the address information on the basis of the reproduction signal RF and also performs a clock generation operation.

For the detection (reproduction) of the address information, the track number information and the sector number information described above are detected.

Also, for the clock generation operation, a PLL processing based on the reproduction signal RF is performed to carry out an operation of generating a reproduction clock.

The address information detected (reproduced) by the address detection and clock generation circuit 23 is supplied to the control section 25. In addition, although a representation in the drawing is omitted, the clock information is supplied as an operation clock for the respective sections.

A spindle control circuit 19 performs a rotation control of the spindle motor 18. In this case, as a rotation control system of the spindle motor 18 (the rotation control of the hologram recording medium HM), for example, a CAV (Constant Angular Velocity) system or a CLV (Constant Linear Velocity) system is adopted.

For confirmation, in a case where the CLV system is adopted, the spindle control circuit 19 inputs the information on the reproduction clock output by the address detection and clock generation circuit 23 as rotation control information and performs the rotation control of the spindle motor 18 so that a cycle of the reproduction clock is set as a predetermined fixed cycle.

A slide mechanism 20 holds an optical unit UN in the drawing in a tracking direction (a radium direction of the hologram recording medium HM) so as to be slidably moved. In this case, the first laser 1, the shutter 2, the Galvano mirror 3, the mirror 4, the SLM 5, the polarization beam splitter 6, the dichroic mirror 7, the mirror 8, the ¼ wavelength plate 9, the objective lens 10, the biaxial mechanism 11, the second laser 12, the polarization beam splitter 13, the photo detector 14, and the image sensor 15 described above are formed in one optical unit UN, and the slide mechanism 20 is provided to hold the optical unit UN so as to be slidably moved in the radium direction of the hologram recording medium HM.

Also, a slide drive section 21 is provided with a motor for driving the slide mechanism 20, and the slide mechanism 20 is configured to slidably move the optical unit UN by way of the driving force of the above-mentioned motor.

On the basis of the focus error signal FE and the tracking error signal TE from the matrix circuit 22, the servo circuit 24 generates various servo signals of focus, tracking, and sled to perform the servo operations.

That is, a focus servo signal and a tracking servo signal are generated in accordance with the focus error signal FE and the tracking error signal TE to be supplied as drive signals for the biaxial mechanism 11 (a focus drive signal and a tracking drive signal). Thus, the focus coil and the tracking coil of the biaxial mechanism are driven and controlled on the basis of the drive signals in accordance with the respective servo signals. With this configuration, a tracking servo loop and a focus servo loop are formed by the photo detector 14, the matrix circuit 22, the servo circuit 24, and the biaxial mechanism 11.

Also, the servo circuit 24 sets the tracking servo loop OFF in accordance with an instruction from the control section 25 and outputs a jump pulse as the tracking drive signal to thereby execute the track jump operation.

It should be noted that the track jump operation according to the present embodiment will be described below.

In addition, the servo circuit 24 slidably drives the slide mechanism 20 by using the slide drive section 21 on the basis of a sled error signal obtained as a lower component of the tracking error signal TE, a seek operation control from the control section 25, and the like to slidably move the entire optical unit UN.

Also, the servo circuit 24 performs a control on the activation and stop of the spindle motor 18 on the basis of an instruction from the control section 25.

The above-mentioned servo-related various operations are controlled, for example, by the control section 25 composed of a micro computer including a CPU (Central Processing Unit), a ROM (Read Only Memory), a RAM (Random Access Memory) and the like.

The control section 25 executes an overall control on the recording and reproduction apparatus by executing, for example, the respective computation processings and control processings on the basis of a program stored in a predetermined memory such as the ROM.

For example, the control section 25 controls the above-mentioned servo-related operations to perform a control on the recording/reproduction position of the hologram.

To be precise, in accordance with a state where reproduction of certain data recorded on the hologram recording medium HM should be performed, first, a seek operation control to a target address is performed. That is, by issuing an instruction to the servo circuit 24, an access operation to the target address is executed. Herein, according to the above-mentioned explanation, at the time of the reproduction of the data (hologram) recorded on the hologram recording medium HM, the reference light based on the first laser light should be applied. For this reason, at the time of the reproduction, together with the above-mentioned seek operation, the drive control operation on the SLM 5 corresponding to the previously explained reproduction time is executed by the recording modulation section 16 so that the reference light is generated in the SLM 5.

Also, for example, in a case where the data is to be recorded at a certain position on the hologram recording medium HM, an instruction is issued to the servo circuit 24 to execute the access operation to the target address, and also an instruction is issued to the recording modulation section 16 to start the drive control operation on the SLM 5 in accordance with the recording data.

Also, at the time of the recording, the opening/closing control on the previously explained shutter 2 is performed. Furthermore, in order that the laser beam scan is performed as an image stabilizer function, the drive control on the Galvano mirror 3 is also performed.

For the control with respect to the Galvano mirror 3, a control is repeatedly performed in which the mirror angle is changed so as to change the emitting angle of the laser beam at a predetermined speed in a predetermined direction (direction matching with the rotation direction, and thereafter, the mirror is returned in the inverse direction. On the other hand, for a control on the shutter 2, the shutter 2 is opened during the emitting angle controlling period (that is, the period during which the spot stand still on the medium: the recording period for the record on 1 hologram), and the shutter 2 is closed during the other periods.

It should be noted that for confirmation, with the above-mentioned control, during the respective recording period for the holograms, a period of no beam irradiation is prepared, and with this configuration, prevention of formation of an unwanted reaction part is realized between the respective holograms recorded on the hologram recording medium HM.

Also, in particular, in the case of the present embodiment, on the basis of the tracking error signal TE from the matrix circuit 22, the address information from the address detection and clock generation circuit 23, and the like, the control section 25 performs a control processing for realizing the track jump operation according to the present embodiment, which will be described below.

### [Track Jump Method According to an Embodiment]

As is understood also from the above description, the recording and reproduction apparatus according to the present embodiment performs the random access on the disc-shaped hologram recording medium HM to perform the recording/reproduction of the hologram.

Herein, in a case where the random access, of course, the track jump to the target address (track) should be performed.

However, as described above, in the hologram recording and reproduction system, the rotation speed of the disc is set relatively slow. Therefore, when the beam spot of the laser light traverses the track composed of the pit string, in some cases, the beam spot traverses the space part (land part) between the pits, and the track traverse is not appropriately detected.

In this point, in the hologram recording and reproduction system, if the track jump operation similar to the case of the optical disc in a related art is performed as it is, the jump operation to the target track may not be appropriately carried out.

In view of the above, according to the present embodiment, the following track jump method is proposed.

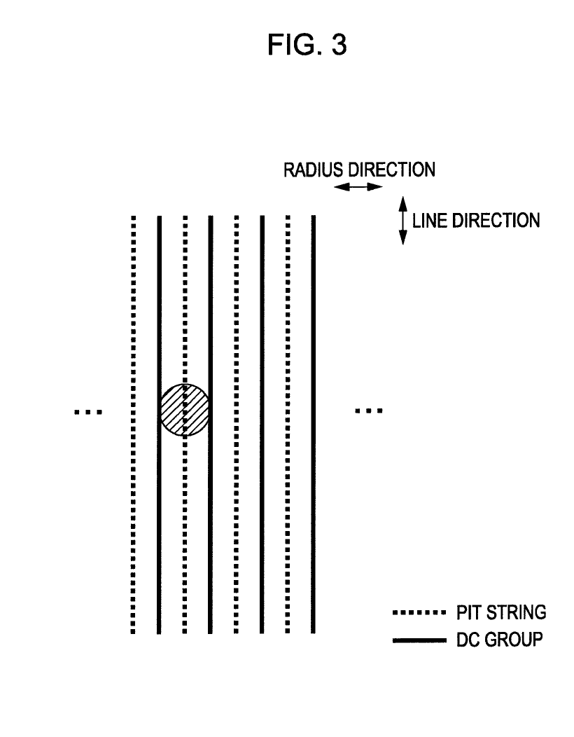

First, for the hologram recording medium HM, not only the address recording track composed of the pit string, a medium on which a DC group (continuous groove) shown in FIG. 3 is formed is used.

FIG. 3 schematically shows a track formed in the track formation layer on the hologram recording medium HM. As shown in the drawing, the lateral direction in the drawing is the radius direction of the hologram recording medium HM. In the direction, the respective tracks are disposed. In addition, the vertical direction orthogonal to the radius direction in the drawing is the line direction (track formation direction).

In the drawing, a broken line represents the address recording track composed of the pit string, and a solid line represents the track composed of the DC group.

It should be noted that for confirmation, in a case where the track is formed in a spiral manner, it can be regarded that the respective tracks are made of one continuous trail from the viewpoint of the entire disc, but from the viewpoint of the radius direction, similarly as in the case of the concentric manner formation, it can be regarded that a plurality of tracks are formed. In the case of the spiral manner formation, the recording start position (rotation angle) is specified on the address recording track composed of the one continuous trail for the respective rounds, and “the respective address recording tracks” are sectioned at a border of the rotation angle.

As shown in FIG. 3, for the hologram recording medium HM according to the present embodiment, a hologram recording medium is adopted in which a track (auxiliary track) based on the DC group is formed so as to run side by side with the address recording track composed of the pit string.

In this case, one trail of the auxiliary track composed of the DC group is formed between the respective address recording tracks so as to run side by side. That is, from the viewpoint of the radius direction, the address recording track and the auxiliary track are alternately disposed.

According to the present embodiment, on the premise that the hologram recording medium HM on which the above-mentioned auxiliary track composed of the DC group is formed is used, the track jump operation is carried out as follows.

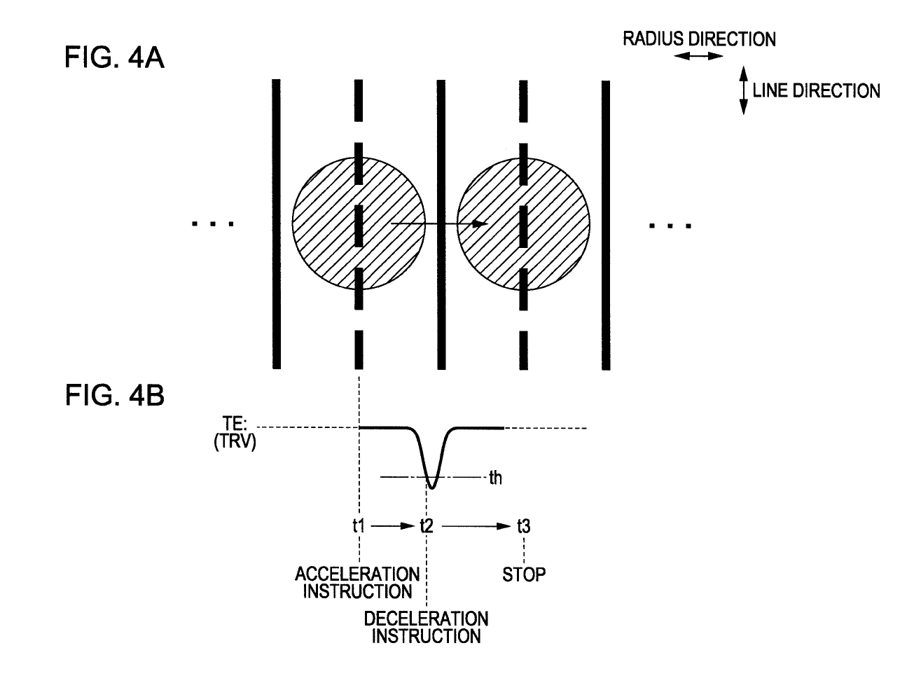

FIGS. 4A and 4B are explanatory diagrams for describing specific example of the track jump operation according to the present embodiment. FIG. 4A shows the address recording track and the auxiliary track disposed in the radius direction of the hologram recording medium HM similarly as in the previously described FIG. 3, and FIG. 4B shows a waveform of the tracking error signal TE (traverse signal TRV) which is obtained when the beam spot is moved in the radius direction while the tracking servo is set OFF.

Herein, as shown in FIGS. 4A and 4B, a state in which the beam spot is located on a certain address recording track is set as a time point t1.

From the time point t1, the laser beam spot is moved in the radius direction. The auxiliary track composed of the DC group is formed so as to run side by side with the respective address recording tracks on the hologram recording medium HM in the case of the present embodiment. Therefore, in accordance with such a movement in the radius direction, at a certain time point t2 after the time point t1, the amplitude of the tracking error signal TE (the traverse signal TRV) becomes a predetermined threshold th or lower. With this configuration, it is possible to detect that the beam spot reaches between the address recording track of the jump origin and the adjacent address recording track.

By utilizing this point, according to the present embodiment, after an acceleration instruction for moving the beam spot in the radius direction is performed in accordance with the start of the track jump, as the amplitude of the traverse signal TRV is equal to or lower than the predetermined threshold th and it is detected that the beam spot reaches the auxiliary track existing between the adjacent address recording track (traverse across the auxiliary track) as described above, a deceleration instruction for stopping the movement of the beam spot in the radius direction is performed.

With this configuration, the beam spot stops at a time point t3 after the time point t2, and accordingly the beam spot can be stopped on the adjacent address recording track.

With the above-mentioned method, according to the present embodiment, even in a case where the rotation speed of the hologram recording medium HM is slow, the track jump to the adjacent address recording track (hereinafter, which will also be referred to as one track jump) can be performed with certainty.

Herein, in the case of the track jump operation utilizing the above-mentioned auxiliary track, when this track jump operation is repeatedly performed by the demanded number of times, the jump operation to the target track can be performed with certainty. However, for example, in a case where the number of jump tracks to the target track is large, it is not efficient at it takes much time to complete the jumps.

In view of the above, according to the present embodiment, in a case where the number of jump tracks to the target track is equal to or larger than a predetermined number, first, “a rough track jump operation” for moving the beam spot by a target distance estimated on the basis of the demanded jump tracks to the target track is performed. Then, a method of performing the track jump operation is adopted by the number in accordance with the number of the demanded jumps from a destination point of this rough track jump operation to the target address recording track. In other words, in a case where the number of the demanded jumps to the target track is large, after the jump operation for a rough adjustment is performed, the track jump operation is performed as a final fine adjustment processing.

Herein, the track pitch between the address recording tracks is previously determined by the recording format. Therefore, the moving distance of the beam spot used for executing the jump operation for the number of the demanded jumps is information obtained in the related art.

Also, as to the tracking coil of the biaxial mechanism 11 for moving the beam spot in the radius direction or the slide motor in the slide drive section 21, upon movement of the beam spot for a certain distance, parameters for supplying the drive signals for which period of time, at which level, and the like are somewhat determined for each product.

In the recording and reproduction apparatus according to the present embodiment, the control section 25 previously stores, for example, track number and distance correspondence information representing a correspondence relation between the number of the jump tracks and the distance with respect to the internal memory such as a ROM.

Also, the servo circuit 24 stores distance and parameter correspondence information representing a correspondence relation among the moving distance of the beam spot, the above-mentioned parameters for the tracking coil, and the above-mentioned parameters for the slide motor.

From the above-mentioned track number and distance correspondence information, the control section 25 obtains information on the distance in accordance with the number of the demanded jumps to the target track and instructs the thus obtained distance information to the servo circuit 24 as information on the target moving distance of the beam spot.

On the basis of the above-mentioned information on the target moving distance, the servo circuit 24 performs the drive control on the tracking coil and the slide motor while following the parameters obtained form the distance and parameter correspondence information.

With this configuration, “the rough track jump operation” described above is executed.

With such a rough track jump operation, it is possible to move the position of the beam spot to the vicinity of the target track.

After the beam spot is moved to the vicinity of the target track through the rough track jump operation in the above-mentioned manner, the read of the address information at the destination point is performed. To be specific, the tracking servo is turned ON, the address information (in particular, the track number information) recorded on the address recording track as the destination point is read.

In a case where the read address information (the track number information) is matched with the track number of the target track, the jump operation is ended.

On the other hand, in a case where the read track number is not matched with the track number of the target track, the number of the demanded jumps to the target track is calculated.

Herein, depending on the accuracy of the rough track jump operation, the number of the demanded jumps calculated herein may be relatively large in some cases. In the present example, when the number of the demanded jumps to the target track calculated after the rough track jump operation is equal to or larger than a predetermined number, the rough track jump operation is performed again. That is, according to the present embodiment, the rough track jump operation is repeatedly performed until the number of the demanded jumps is smaller than the predetermined number, and as the number of the demanded jumps becomes lower than the predetermined number, the track jump operation is performed by the number of the demanded jumps to the target track.

In this way, the threshold for the number of the demanded jumps for determining whether which one of the rough track jump/the one track jump is executed is set as “n”. In the case of the present example, when determining which one of the rough track jump/the one track jump is executed, the threshold n is regularly used. That is, in a case where the determination on the rough track jump/the one track jump is performed for the first time since the new target track is set and the determination on the rough track jump/the one track jump is performed again after the rough track jump operation, the threshold n is used.

### Processing Procedure

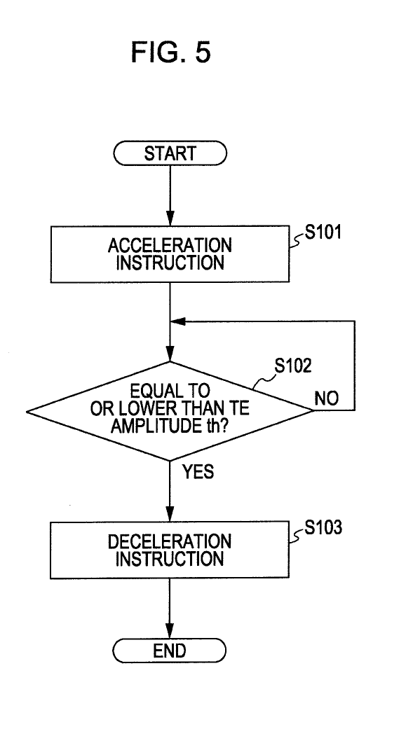

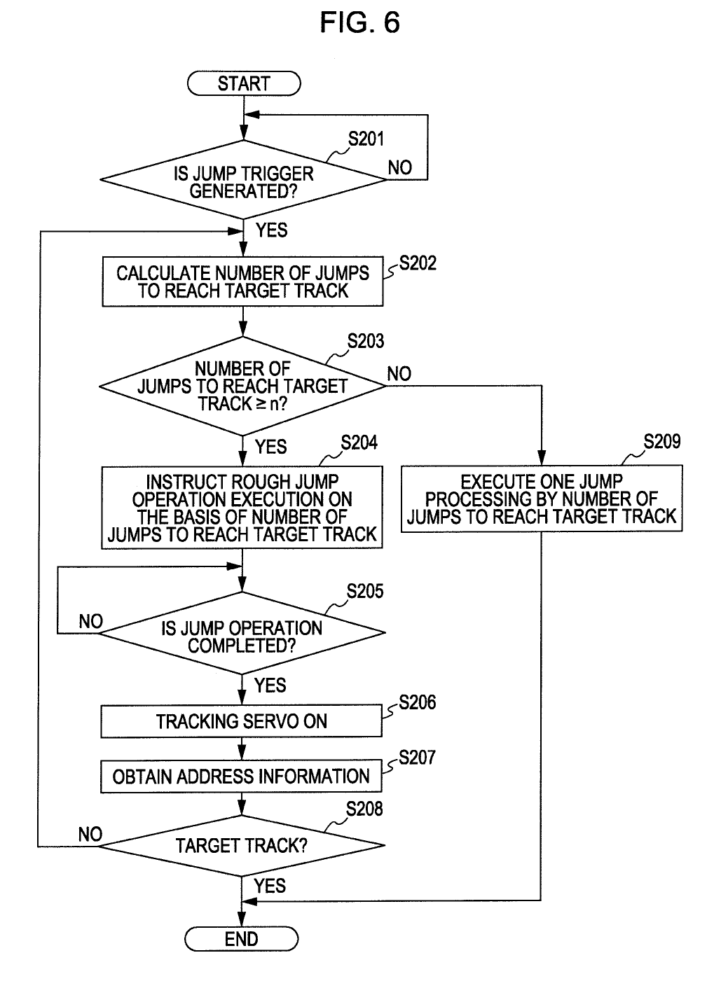

Subsequently, a processing procedure for realizing the track jump operation described above according to the present embodiment will be described with use of flow charts of FIGS. 5 and 6.

FIG. 5 shows a procedure for a processing that should be executed for realizing the track jump operation described above, and FIG. 6 shows a procedure for a processing that should be executed for realizing the overall track jump operation until the target track including the above-mentioned rough track jump operation is reached.

It should be noted that in FIGS. 5 and 6, the procedure for the processing for realizing the track jump operation according to the present embodiment are represented as the procedure for the processing executed by the control section 25 on the basis of the program stored in the internal ROM or the like as shown in FIG. 1.

First, a flow chart of FIG. 5 will be described.

The control section 25 performs an acceleration instruction in step S101 of the drawing. That is, an instruction is issued to the servo circuit 24 so that an acceleration pulse for moving the beam spot in the target track direction is provided as the drive signal for the tracking coil in the biaxial mechanism 11.

In subsequent step S102, the process stands by until the amplitude of the tracking error signal TE is equal to or lower than the previously determined threshold th.

Then, as the amplitude of the tracking error signal TE is equal to or lower than the previously determined threshold th, in step S103, a deceleration instruction is performed. To elaborate, an instruction is issued to the servo circuit 24 so that the beam spot which is moved in accordance with the acceleration instruction in step S101 is stopped as the drive signal for the tracking coil in the biaxial mechanism 11.

When the deceleration instruction in step S103 is performed, the processing for the track jump operation is ended.

Herein, the series of processing for the track jump operation shown in FIG. 5 is referred to as one track jump processing.

FIG. 6 shows a processing procedure for realizing the overall track jump operation also including the track jump operation for realizing the above-mentioned one track jump processing.

First, in step S201, the process stands by for generation of a jump trigger. That is, the process stands by until a state is established in which an access operation targeted to the predetermined address should be executed and a state is established in which the track jump operation to the target track should be executed.

Then, in a case where the state is established in which the track jump operation to the target track should be executed (that is, the jump trigger is generated), in step S202, the number of the demanded jumps to the target track is calculated. To elaborate, a computation in which “the track number of the target track”—“the current track (track at which the beam spot is currently located)” is performed to obtain the number of the demanded jumps to the target track.

In subsequent step S203, it is determined whether or not the number of the demanded jumps is equal to or larger than a predetermined threshold n. To elaborate, it is determined whether or not the value of the demanded jumps calculated in step S202 is equal to or larger than the threshold n of the number of the demanded jumps for determining which one of the previously explained the rough track jump/the one track jump is executed.

In step S203, in the case of YES as the number of the demanded jumps is equal to or larger than the threshold n, in step S204, an instruction is issued for executing the rough track jump operation based on the number of the demanded jumps.

That is, from the above-mentioned track number and distance correspondence information, information on a distance in accordance with the number of the demanded jumps to the target track is obtained, and the thus obtained information on the distance is instructed to the servo circuit 24 as the target moving distance of the beam spot, so that “the rough track jump operation” is executed.

Herein, the rough track jump operation is performed through the slide movement of the entire optical unit UN by the slide drive section 21 or the movement in the tracking direction of the objective lens 10 by the tracking coil of the biaxial mechanism 11. In this case, the number of tracks which can be jumped by the tracking coil is limited to a predetermined number (limited to within so-called optical view field). In a case where, the number of the demanded jumps to the target track is equal to or smaller than this predetermined number, the control section 25 also performs an instruction indicating the rough track jump operation using the tracking coil together with the instruction of the information on the distance. On the other hand, in a case where the number of the demanded jumps to the target track exceeds the predetermined number, the instruction indicating the rough track jump operation using the slide drive section 21 is performed.

Also, for confirmation, upon executing the above-mentioned rough track jump operation, in a case where the tracking servo is in the ON state, in step S204, an instruction for turning the tracking servo OFF is also issued to the servo circuit 24.

In subsequent step S205, the process stands by until completion of the jump operation. That is, the process stands by until completion of the rough track jump operation which is instructed in step S204.

In this case, whether the rough track jump operation is completed or not is determined, for example, on the basis of the presence or absence of a completion notification from the servo circuit 24. That is, the servo circuit 24 in this case performs a control on the biaxial mechanism 11 or the slide drive section 21 on the basis of the parameters obtained from the above-mentioned distance and parameter correspondence information at the time of the rough track jump operation. In accordance with completion of this control operation, the control section 25 is notified of the completion of the rough track jump operation.

A processing in step S205 in this case corresponds to a processing of waiting for such a completion notification from the servo circuit 24.

In a case where the above-mentioned completion notification is performed and the completion of the rough track jump operation is confirmed, the tracking servo in step S206 is set as the ON processing, and an instruction is performed for causing the servo circuit 24 to turn ON the tracking servo.

Then, in next step S207, a processing of obtaining the address information is performed. To elaborate, the address information is obtained which is input from the address detection and clock generation circuit 23 in accordance with the state in which the tracking servo is turned ON in step S206.

In subsequent step S208, it is determined whether the track is the target track or not. That is, it is determined whether the track number information included in the address information obtained in step S207 (the track number information on the track where the beam spot is currently located) is matched with the track number information of the target track.

In this step S208, in the case of YES as the current track is the target track, the processing for the track jump operation is ended as shown in the drawing.

On the other hand, in step S208, in the case of NO as the current track is not the target track, the process is returned to step S202, the number of the demanded jumps to the target track is calculated again.

Herein, after the number of the demanded jumps is calculated in step S202, it is determined whether or not the number of the demanded jumps is equal to or larger than the threshold n in step S203. In a case where it is determined that the number of the demanded jumps is equal to or larger than the threshold n in step S203, the following processing is performed again from the rough track jump operation (S204) to the determination as to whether or not the track is the target track (S208). That is, with this configuration, until the number of the demanded jumps is smaller than the threshold n, the rough track jump operation is repeatedly performed.

Then, in step S203, in the case of NO as the number of the demanded jumps is not equal to or larger than the threshold n, the processing advances to step S209, and the one track jump processing of the present example is executed by the number of the demanded jumps. That is, the one track jump processing previously explained in FIG. 5 is executed by the number of times in accordance with the number of the demanded jumps. With this configuration, it is possible to each the target track with certainty.

When the processing in step S209 is executed, the processing shown in this drawing is ended.

As described above, according to the present embodiment, the auxiliary track composed of the DC group running side by side with the address recording track composed of the pit string is formed on the hologram recording medium HM. On the basis of the reflection light information at the time of traverse across the auxiliary track (in this case, the traverse signal TRV), the radius direction positional control on the beam spot is performed to carry out the track jump operation. With this configuration, the situation in the related art can be prevented in which it is difficult to correctly perform the track jump in a case where the rotation speed of the hologram recording medium HM is slow, and the track jump to the target track can be correctly performed.

As a result, according to the present embodiment, for the hologram recording and reproduction system for performing the recording/reproduction of the hologram at the position along the track, it is provide the system in which the access operation to the target address can be appropriately performed.

### Second Embodiment

Subsequently, a second embodiment of the present invention will be described.

The second embodiment is proposed by changing the technique for the tracking servo.

Herein, according to the first embodiment, the tracking servo is applied while using the address recording track composed of the pit string as the target, but depending on a setting of the rotation speed of the disc, the band of the tracking error signal TE is not suitable, the tracking servo may not be appropriately applied.

In view of the above, according to the second embodiment, a plurality of beam spots of the second laser light are formed, and one spot among those corresponds to the address recording track composed of the pit string, and another spot of those corresponds to the auxiliary track composed of the DC group. Then, the tracking servo is applied in accordance with the tracking error signal TE generated from the reflection light of the beam spot corresponding to the auxiliary track.

### FIRST EXAMPLE

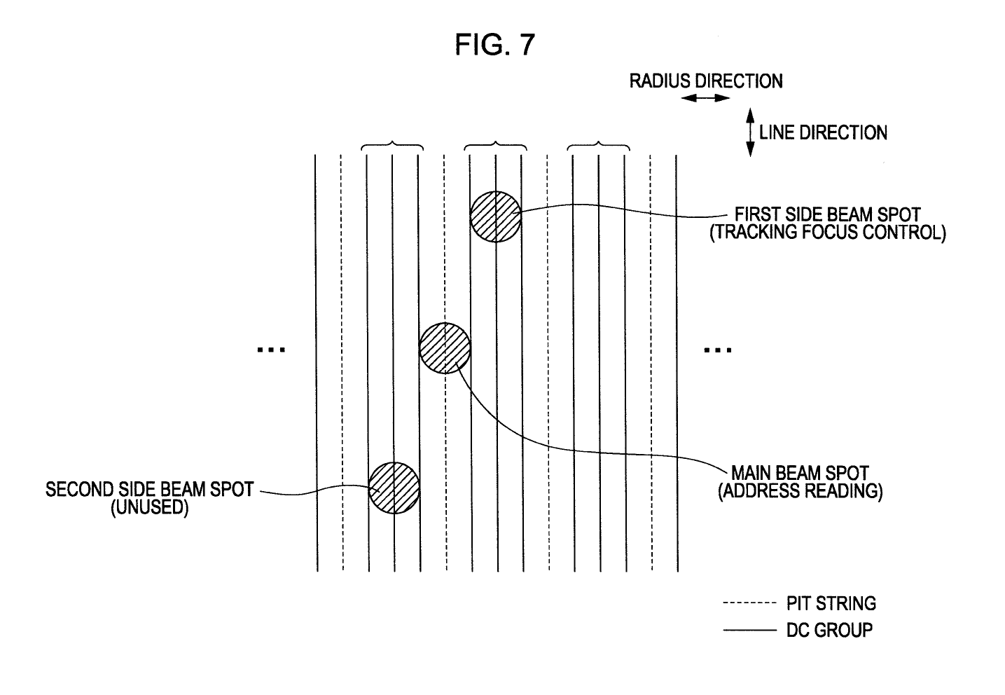

FIG. 7 is an explanatory diagram for describing a first example of the second embodiment.

In FIG. 7, a relation between the respective tracks formed on the hologram recording medium HM and the beam spot is exemplified.

First, in this case too, the address recording track composed of the pit string and the auxiliary track composed of the DC group running side by this address recording track side with are formed the hologram recording medium HM. However, the number of the auxiliary tracks is changed from the case of the first embodiment. As shown in the drawing, three auxiliary tracks are inserted between the respective address recording tracks in this case.

Then, in this case, in the recording and reproduction apparatus, as to the second laser light for the positional control, three beam spots are formed as shown in the drawing. Herein, the central beam spot is set as a main beam spot, and side beam spots other than the central beam spot are respectively set as a first beam spot and a second beam spot.

Then, in the case of the first example shown in FIG. 7, the main beam spot corresponds to the address recording track, and one first beam spot corresponds to the central auxiliary track among the three auxiliary tracks. That is, the address information recorded on the pit string is read by the main beam spot, and the tracking servo and the focus servo along the central auxiliary track are performed by the first beam spot.

It should be noted that as described in the drawing too, in this case, the second beam spot is not used.

In this case, the separating distance between the main beam spot and the first beam spot in the radius direction is adjusted so as to have such a relation that when the first beam spot traces on the central auxiliary track of the three auxiliary tracks, the main beam spot traces on the address recording track as shown in the drawing. With this configuration, as the tracking servo is performed by the first beam spot, the main beam spot traces on the pit string.

Also, the optical axis of the first laser light for recording and reproducing the hologram is set to be matched with the main beam spot. Therefore, in the case of the first example shown in FIG. 7, the hologram is recorded on the address recording track.

It should be noted that although an explanation by way of the drawing is omitted, in the case of the first example, a beam dividing element configured to divide the second laser light into three beams is inserted into the recording and reproduction apparatus in the optical system of the second laser light. In addition, for the photo detector 14, a main light receiving element configured to receive the reflection light of the main beam spot and a sub light receiving element configured to receive the reflection light of the first beam spot are provided. The matrix circuit 22 is configured to generate the reproduction signal RF on the basis of a reception light signal from the main light receiving element and generate the tracking error signal TE and the focus error signal FE on the basis of a reception light signal from the sub light receiving element.

Also, as will be described below, in the case of the first example, a signal monitored by the control section 25 at the time of the track jump operation is not the tracking error signal TE but the reproduction signal RF (that is, the traverse of the main beam spot across the auxiliary track is detected). Therefore, the reproduction signal RF generated in the matrix circuit 22 is input to the control section 25 in this case.

In the case of the first example, the track jump operation is performed as follows.

First, in this case too, at the start of the track jump operation, the control section 25 performs the acceleration instruction for moving the beam spot with respect to the servo circuit 24 in the target track direction. Then, for the control section 25 in this case too, after the acceleration instruction is performed, the processing is common up to the detection of the timing at which the amplitude of the monitor signal (in this case, the reproduction signal RF) is equal to or lower than a predetermined threshold. However, in this case, while corresponding to the state in which the number of the auxiliary tracks between the address recording tracks is three, at a timing at which the amplitude of the monitor signal (the reproduction signal RF) becomes equal to or lower than the predetermined threshold for the second time, the deceleration instruction with respect to the servo circuit 24 is performed.

With this configuration, it is possible to carry out the one track jump to the adjacent address recording track.

It should be noted that for confirmation, in the case of the second embodiment, only the processing at the time of the one track jump is different, the processing for realizing the overall track jump operation to reach the target track is similar to that described with reference to FIG. 6. Thus, the repeated description is omitted.

Herein, according to the first example described with reference to FIG. 7, the case is exemplified in which the three auxiliary tracks based on the DC group are inserted between the respective address recording tracks, but the number of the auxiliary tracks is not particularly limited to three.

In a case in which one auxiliary track is used, for example, similarly as in the case of the first embodiment, a switching timing from the acceleration to the deceleration at the time of the one track jump may be set as the timing at which the pulse equal to or smaller than the predetermined threshold is detected for the first time after the acceleration instruction.

Also, for example, In a case in which two auxiliary tracks are used, depending on a formation distance between the respective tracks, for example, if the switching of the acceleration→the deceleration is performed at an intermediate timing between the first pulse and the second pulse, the one track jump can be carried out.

In either case, the auxiliary track to be inserted between the respective address recording tracks is the DC group, and the traverse can be detected with certainty by the reflection light signal at the time of the traverse. Therefore, by switching acceleration/deceleration on the basis of the reflection light signal at the time of the auxiliary track traverse, it is possible to carry out the one track jump to the adjacent address recording track with certainty.

### SECOND EXAMPLE

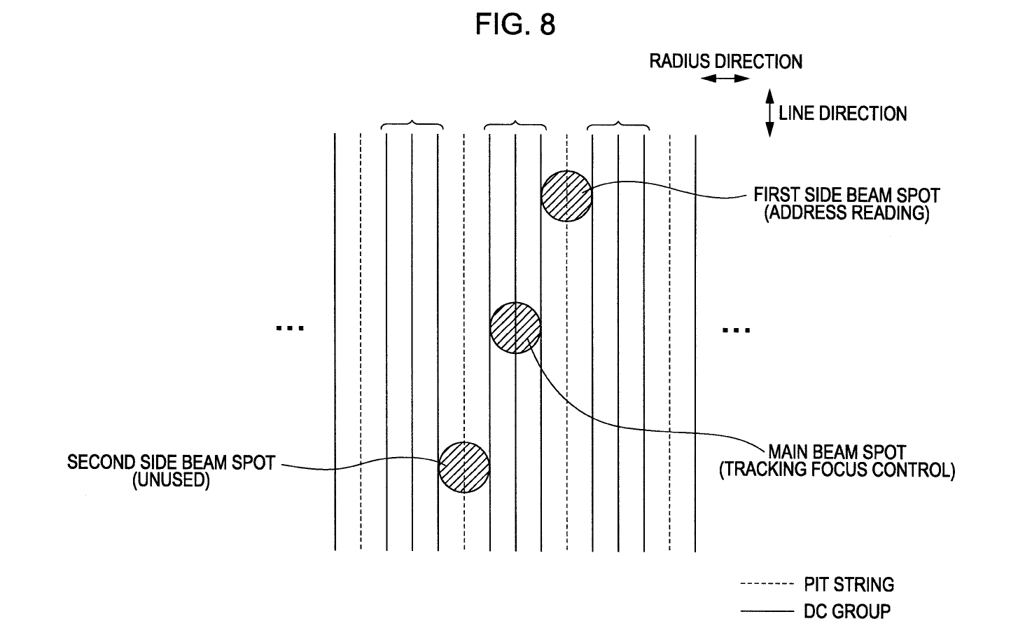

FIG. 8 is an explanatory diagram for describing a second example of the second embodiment.

Similarly to FIG. 7, FIG. 8 also exemplifies a relation between the respective tracks formed on the hologram recording medium HM and the beam spot.

As shown in the drawing, this case is also similar to the first example case in terms of the construction of the hologram recording medium HM. In addition, the point in which three beam spots are formed for the second laser light is also similar to the first example case.

The second example is different from the first example in which the tracking servo and the focus servo based on the central auxiliary track is performed by the main beam spot, and read of the address information recorded on the address recording track is performed by the first beam spot.

To elaborate, according to the second example, as the tracking servo is performed while setting the central auxiliary track of the three auxiliary tracks by the main beam spot as the target, the first beam spot traces on the address recording track.

In this case too, the optical axis of the first laser light for recording and reproducing the hologram is matched with the main beam spot. Therefore, in the case of the second example, the hologram is recorded on the central auxiliary track.

It should be noted that in this case too, the second beam spot is not used.

In the recording and reproduction apparatus according to the second example case, in the photo detector 14, the matrix circuit 22 is configured to generate the tracking error signal TE and the focus error signal FE on the basis of the reception light signal from the above-mentioned main light receiving element and generate the reproduction signal RF on the basis of the reception light signal from the above-mentioned sub light receiving element.

Also, in this case, at the time of the track jump operation, the timing at which the first beam spot traverses the auxiliary track is detected. Thus, the tracking error signal TE generated in the matrix circuit 22 is input to the control section 25.

The one track jump processing according to the second example case is similar to the previously explained one track jump processing according to the first example case except that the monitor signal for the control section 25 to detect the timing for performing the deceleration instruction is the tracking error signal TE. That is, in this case, when the first beam spot traverses the central auxiliary track, the switching of the acceleration→the deceleration is performed. With this configuration, the one track jump to the adjacent address recording track is carried out.

It should be noted that in the second example too, the processing for realizing the overall track jump operation to reach the target track is similar to those described in FIGS. 5 and 6, and the repeated description is omitted.

According to the second embodiment described above, as the tracking servo can be performed while setting the auxiliary track composed of the DC group formed on the hologram recording medium HM as the target, irrespective of the setting of the rotation speed of the disc, the stable tracking servo can be realized.

### MODIFIED EXAMPLES

In the above, embodiments of the present invention are described, but the present invention should not be limited to the above-mentioned specific examples.

For example, in the above description, the control for realizing the track jump operation according to the embodiment is performed by the control section 25. However, such a configuration may be adopted that the control section 25 merely issues the instruction of the target address (the target track), and the servo circuit 24 performs the control while following the procedure described with reference to FIGS. 5 and 6 and the like on the basis of the information on the target track, so that the track jump operation according to the embodiment is realized.

Also, in the above description, the case in which the recording/reproduction of the hologram and the positional control thereof are performed by using separate laser light sources having different wavelengths is exemplified. However, the recording/reproduction of the hologram and the positional control can also be performed by only using the laser light source for the recording/reproduction of the hologram.

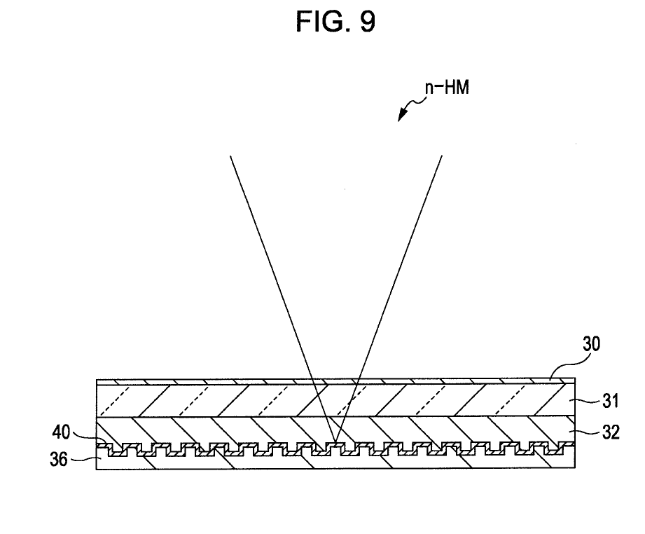

FIG. 9 shows an example of a cross sectional structure of a hologram recording medium in this case (which is set as a hologram recording medium n-HM).

For the hologram recording medium n-HM, as compared with the hologram recording medium HM shown in FIG. 2, the hologram recording medium is different that the reflection film 33 and the intermediate layer 34 are omitted. Based on the above, for the reflection film on the substrate 36 in this case, a reflection film 40 adopted to reflect the laser light for recording and reproducing the hologram is used, and the recording layer 32 is formed on the reflection film 40.

Herein, in a case where the recording/reproduction of the hologram and the positional control are carried out by only using the laser light source for the recording/reproduction of the hologram, the configuration of the optical system may be changed in such a manner that for the recording and reproduction apparatus, the reflection light from the hologram recording medium n-HM is guided to both the image sensor 15 side and the photo detector 14 side.

It should be noted that when the hologram is recorded on the address recording track composed of the pit string, at the time of the reproduction of the recorded hologram, noise is generated on the reproduction light of the hologram in accordance with concavity and convexity of the pit string, and the detection accuracy for the reproduction light of the hologram may be decreased in some cases. In view of the above, this problem can be avoided while the beam spot is divided as in the example of FIGS. 7 and 8, and the read of the address information recorded on the address recording track composed of the pit string and the tracking servo are performed by the side beam, and the recording and reproduction of the hologram is performed by the main beam. That is, by adopting such a technique, the hologram is recoded and reproduced at a position away from the pit string by a predetermined distance (a distance from the side beam spot to the main beam spot), and the reproduction of the hologram can be performed without an influence from the pit string.

Also, in the above description, the case is exemplified in which the recording and reproduction are performed with respect to the reflective hologram recording medium provided with the reflection film, but the embodiment of the present invention can be also suitably applied to a case in which the recoding is performed with respect to a transmissive hologram recording medium which is not provided with the reflection film.

In the case of using the transmissive hologram recording medium, for the recording and reproduction apparatus, the provision of the polarization beam splitter 6 (and the ¼ wavelength plate 9) for guiding the reproduction light obtained as the reflection light in accordance with the applied reference light to the image sensor 15 side can be avoided. In addition, the provision of the polarization beam splitter 13 for guiding the reflection light from the track formation layer (the reflection light for the positional control) to the photo detector 14 side can also be avoided.

In this case, the reproduction light obtained in accordance with the application of the reference light transmits through the hologram recording medium itself. Thus, a configuration may be adopted that an object lens is further provided on an opposite side of the hologram recording medium as seen from the laser light emitting point side, and the reproduction light functioning as the transmission light is guided to the image sensor 15 side via the object lens. Similarly, the reproduction light of the laser light for the positional control transmitting through the track formation layer transmits through the hologram recording medium itself too. Thus, a configuration may be adopted that the reproduction light functioning as the transmission light is guided to the photo detector 14 side via the object lens.

Also, the above description exemplifies the case in which the embodiment of the present invention is applied when the coaxial system is adopted for performing the recording while the reference light and the signal light are arranged on the same axis. The embodiment of the present invention can also be suitably applied to a case in which a so-called two light flux system is adopted for separately applying the signal light and the reference light at the time of the recording.

In this case, the configuration of the optical system may be changed in such a manner that for the recording and reproduction apparatus, a set of the light source for generating the signal light at the time of the recording and the SLM and a set of the light source for generating the reference light and the SLM are separately provided, and the signal light and the reference light respectively generated are guided to the hologram recording medium at different angles.

Also, in the above description, only the hologram recording medium functioning as the recordable medium which has the recording layer on which the hologram is formed by way of the interference pattern of the signal light and the reference light is mentioned. The embodiment of the present invention can also be suitably applied to a case in which the hologram recording medium functioning as a reproduction dedicated medium is used.

For the hologram recording medium functioning as the reproduction dedicated medium, for example, the hologram is formed on the recording layer through a microfabrication such as lithography to record the data. Other structures of the track formation layer may be similar to those described in the above, and the processing at the time of the track jump may also be similar to that described in the above.

Also, as is understood from this viewpoint, it is not necessary for the drive apparatus according to the embodiment of the present invention to have the recording function and the drive apparatus may have a structure to function as a reproduction dedicated apparatus. In addition, the drive apparatus may also have a structure to function as a recording dedicated apparatus capable of performing the recording with respect to the hologram recording medium which functions as the recordable medium.

The present application contains subject matter related to that disclosed in Japanese Priority Patent Application JP 2008-166244 filed in the Japan Patent Office on Jun. 25, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A drive apparatus comprising:
light irradiation means configured to apply light from a light source via an object lens on a hologram recording medium provided with a recording layer on which a hologram is formed and a track formation layer on which an address recording track composed of a pit string which records address information representing a recording position of the hologram on the recording layer and an auxiliary track composed of a continuous groove formed so as to run side by side with the address recording track are formed;
light spot displacement means configured to displace a light spot formed by the light irradiation means in a radius direction of the hologram recording medium; and
control means configured to control the light spot displacement means on the basis of a light information signal at the time of the auxiliary track traverse of the light spot obtained in accordance with displacement of the light spot in the radius direction to execute a jump operation between the address recording tracks.

2. The drive apparatus according to claim 1,
wherein the control means issues an acceleration instruction to the light spot displacement means for starting movement of the light spot in the radius direction and then issues a deceleration instruction for stopping the movement of the light spot in accordance with obtainment of the light information signal at the time of the auxiliary track traverse of the light spot to execute the jump operation to an adjacent address recording track.

3. The drive apparatus according to claim 2,
wherein the control means performs a control on the light spot displacement means to move the light spot by a target distance estimated from a number of demanded jumps to a target address recording track and then performs a control to execute a track jump operation to the adjacent address recording track by a number of times in accordance with the number of the demanded jumps from a destination point to the target address recording track.

4. The drive apparatus according to claim 3,
wherein the light irradiation means performs light irradiation for forming a plurality of light spots in which an interval between a first light spot and a second light spot among the light spots is set as an interval between the address recording track and the auxiliary track formed on the hologram recording medium,
the drive apparatus further comprising:
tracking servo control means configured to control the light spot displacement means to cause the first light spot to trace on the auxiliary track on the basis of a result of detecting a positional relation between the first light spot and the auxiliary track in a state in which the hologram recording medium is rotated and driven; and
address information reproduction means configured to reproduce the address information on the basis of the light information signal obtained while the second light spot traces on the address recording track as the tracking servo control means performs the tracking servo control, and
wherein the control means issues the acceleration instruction to the light spot displacement means and then issues the deceleration instruction in accordance with obtainment of the light information signal of the second light spot at the time of the traverse across the auxiliary track.

5. The drive apparatus according to claim 1,
wherein the hologram recording medium is configured as a recordable medium having a recording layer on which recording of a hologram based on an interference pattern of a signal light generated through a spatial light modulation in accordance with recording data and a reference light generated through a spatial light modulation in accordance with a predetermined data pattern is performed for the recording layer,
the drive apparatus further comprising:
spatial light modulation means configured to apply a spatial light modulation on incident light to generate the signal light and the reference light, and
wherein the light irradiation means irradiate the hologram recording medium via the objective lens with the signal light and the reference light obtained by the spatial light modulation means.

6. The drive apparatus according to claim 1, further comprising spatial light modulation means configured to apply a spatial light modulation on incident light to generate a reference light for obtaining a reproduction light related to the hologram recorded on the recording layer in the hologram recording medium,
wherein the light irradiation means irradiates the hologram recording medium via the objective lens with the reference light obtained by the spatial light modulation means, and
the drive apparatus further comprising reproduction light detection means configured to detect the reproduction light obtained in accordance with the irradiation of the hologram recording medium with the reference light.

7. A track jump method comprising the steps of:
applying light from a light source via an object lens on a hologram recording medium provided with a recording layer on which a hologram is formed and a track formation layer on which an address recording track composed of a pit string which records address information representing a recording position of the hologram on the recording layer and an auxiliary track composed of a continuous groove formed so as to run side by side with the address recording track are formed; and
controlling, on the basis of a light information signal obtained in accordance with displacement of the formed light spot in a radius direction of the hologram recording medium at the time of traverse of the light spot across the auxiliary track, a displacement operation of the light spot in the radius direction to execute a jump operation between the address recording tracks.

8. A drive apparatus comprising:
a light irradiation section configured to apply light from a light source via an object lens on a hologram recording medium provided with a recording layer on which a hologram is formed and a track formation layer on which an address recording track composed of a pit string which records address information representing a recording position of the hologram on the recording layer and an auxiliary track composed of a continuous groove formed so as to run side by side with the address recording track are formed;
a light spot displacement section configured to displace a light spot formed by the light irradiation section in a radius direction of the hologram recording medium; and
a control section configured to control the light spot displacement section on the basis of a light information signal at the time of the auxiliary track traverse of the light spot obtained in accordance with displacement of the light spot in the radius direction to execute a jump operation between the address recording tracks.
